(19) United States
(12) Patent Application Publication
(10) Pub. No.: US 2004/0146682 A1
(43) Pub. Date: Jul. 29, 2004

(54) Decal form with sub-surface window

(76) Inventor: David Emmert, Angola, IN (US)

Correspondence Address: NIXON & VANDERHYE, PC, 1100 N GLEBE ROAD, 8TH FLOOR, ARLINGTON, VA, 22201-4714, US

(21) Appl. No.: 10/353,009

(22) Filed: Jan. 29, 2003

(51) Int. Cl. B32B 31/00; B32B 9/00

(52) U.S. Cl. 428/40.1; 156/268

(57) ABSTRACT

A decal form includes a laminate construction of a base sheet and a cover sheet with a patch of adhesive release material formed on the base sheet between the base sheet and the cover sheet. A decal window for receiving a decal is die cut from the cover sheet exposing the adhesive release material patch. A decal may be releasably affixed in the window over the adhesive release material patch. The form can be used in sheet form, fanfold form, or roll and can be used as a mailer or for individual use.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND AND SUMMARY OF THE INVENTION

The present invention relates generally to a decal form construction and, more particularly, to a decal form construction that is effective for decal mailers and the like and has simplified construction.

There are many situations where it is desirable to forward a decal by mail or the like to a recipient. The decal form should enable easy removal of the decal and should be simple in construction. An existing decal form is complicated in construction and requires four different applications in the manufacturing process. A window is die cut from a first sheet, and after applying an adhesive, a silicone paper patch is glued on the back of the window. The face of the sheet then has a window with an exposed silicone area. A decal is inserted onto the exposed silicone area. The glued on patch, however, complicates the manufacture process and causes surfaces of the form to be non-uniform.

It would be desirable to construct a decal form that is less complicated to manufacture while being better suited for a laser printer and being more durable.

In an exemplary embodiment of the invention, a decal form includes a base sheet having a front side and a back side; a patch of adhesive release material applied to the front side of the base sheet; a cover sheet affixed to the front side of the base sheet covering the base sheet and adhesive release material patch, the cover sheet being affixed with a permanent adhesive; a window die cut from the cover sheet exposing the adhesive release material patch; and a decal releasably affixed in the window over the adhesive release material patch.

The adhesive release material is preferably silicone. The cover sheet may comprise a PS material that is at least 60# paper or synthetic material. The decal is preferably sized smaller than the window and is releasably affixed in the window over the adhesive release material patch via an adhesive, or is affixed to a liner with the decal and liner being releasably affixed in the window over the adhesive release coating via an adhesive.

In another exemplary embodiment of the invention, a decal form is constructed of a laminate construction of a base sheet and a cover sheet with a patch of adhesive release material formed on the base sheet between the base sheet and the cover sheet. A decal window for receiving a decal is die cut from the cover sheet exposing the adhesive release material patch.

In yet another exemplary embodiment of the invention, a method of constructing a decal form includes the steps of (a) applying a patch of adhesive release material to one side of a base sheet; (b) affixing a cover sheet to the base sheet covering the base sheet and adhesive release material patch; (c) die cutting a window section in the cover sheet adjacent the adhesive release material patch; and (d) removing the window section of the cover sheet to define a window exposing the adhesive release material patch. Preferably, step (d) is practiced via suction. The method may further include, after step (a), the step of printing an ink material over the adhesive release material patch. Step (b) may be practiced by laminating the cover sheet and the base sheet together. Additionally, the method may further include, after step (d), the step of releasably affixing a decal in the window over the adhesive release material patch.

### BRIEF DESCRIPTION OF THE DRAWINGS

These and other aspects and advantages of the present invention will be described in detail with reference to the accompanying drawings, in which:

FIG. 1 shows the base sheet front side of the decal form according to the present invention;

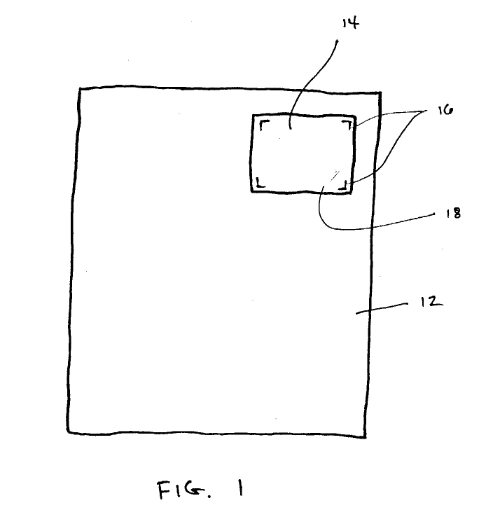

FIG. 2 is a perspective view showing the face sheet and cover sheet;

FIG. 3 illustrates the completed decal form; and

FIG. 4 is a cross sectional side schematic view along the line 4-4 in FIG. 3.

### DETAILED DESCRIPTION OF THE INVENTION

With reference to the FIGURES, the decal form of the present invention includes a base sheet 12, preferably a liner or paper based material. A patch of adhesive release material 14 such as silicon or the like is applied or “printed” on the front side of the base sheet 12. Holding marks 16 may be printed on the base sheet 12 to facilitate application of the adhesive release material patch 14.

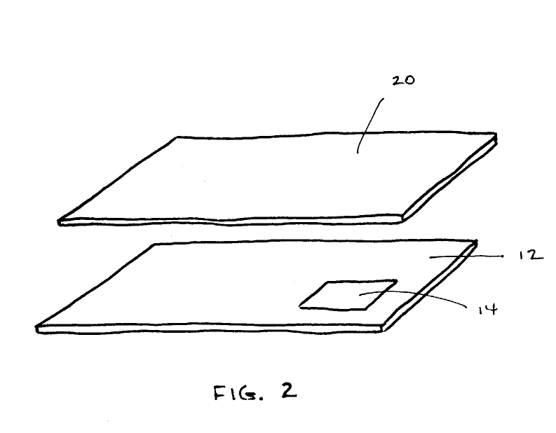

With reference to FIG. 2, a cover sheet 20 is affixed to the front side of the base sheet 12 covering the base sheet 12 and adhesive release material patch 14. An ink material 18 may be printed over the adhesive release material patch 14 to “deaden” the cover sheet 20 adhesive when the cover sheet 20 is laminated with the base sheet 12. The cover sheet 20 is preferably affixed with a permanent adhesive or otherwise laminated to form an integrated sheet construction. The cover sheet preferably comprises a pressure sensitive (PS) material of at least 60# paper or synthetic material.

After laminating the base sheet 12 and cover sheet 20, a window 22 is die cut from the cover sheet 20, and the die cut section is removed via suction (vacuum) or the like exposing the adhesive release material patch 14 applied on the base sheet 12.

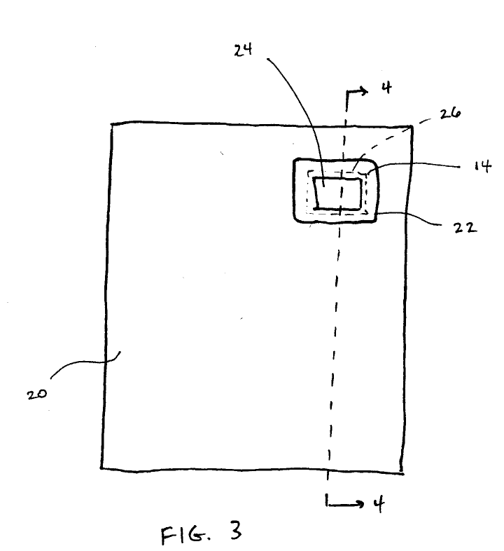

A decal 24 can be releasably affixed in the window 22 over the adhesive release material patch 14. The decal 24 can be affixed in the window 22 with an exposed adhesive thereon, which is releasable by the adhesive release material patch 14. Alternatively, the decal 24 may be affixed in the window 22 with a liner 26 (shown in phantom in FIG. 3) attached. The decal can be formed of any construction suitable for the intended end purpose. In one arrangement, the decal is made from retro-reflective material or any synthetic material that qualifies with user requirements. The decal 24 is die cut to a size smaller than the window 22.

Preferably, the decal 24, with or without liner 26, is applied via a known label applicator. The laminated base sheet 12 and cover sheet 20 are put through the applicator, and the decal 24 is then wiped or placed into the window 22 on the base sheet 12. The form is then complete and can be used in sheet form, fanfold form (continuous), or roll. The form can be used as a mailer or for individual use.

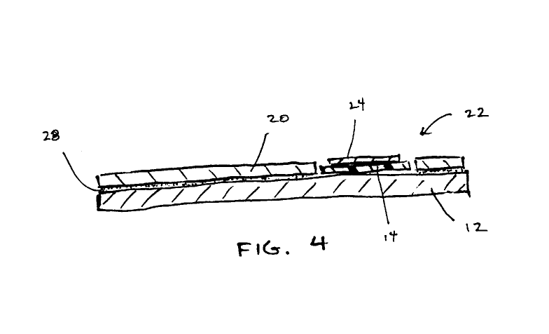

FIG. 4 is a sectional view along the line 4-4 in FIG. 3. Of course, the dimensions of the various layers are exaggerated to facilitate illustration. As shown in FIG. 4, the base sheet 12 has the adhesive release material patch 14 applied thereto with the cover sheet 20 affixed via an adhesive 28 or the like. A portion of the cover sheet 20 is removed via die cutting to form the window 22, exposing the adhesive release material patch 14. The decal 24 is releasably affixed in the window 22 over the adhesive release material patch 14.

With the construction of the present invention, the decal form will need only three applications for manufacture, including lamination, die cut and decal application. Moreover, the constructed form is more durable than existing forms due to the laminated construction and is better suited for printing via a laser printer.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A decal form comprising:
a base sheet having a front side and a back side;
a patch of adhesive release material applied to the front side of the base sheet;
a cover sheet affixed to the front side of the base sheet covering the base sheet and adhesive release material patch, the cover sheet being affixed with a permanent adhesive;
a window die cut from the cover sheet exposing the adhesive release material patch; and
a decal releasably affixed in the window over the adhesive release material patch.

2. A decal form according to claim 1, wherein the adhesive release material is silicone.

3. A decal form according to claim 1, wherein the cover sheet comprises a pressure sensitive (PS) material.

4. A decal form according to claim 3, wherein the PS material is at least 60# paper or synthetic material.

5. A decal form according to claim 1, wherein the decal is sized smaller than the window.

6. A decal form according to claim 1, wherein the decal is releasably affixed in the window over the adhesive release material patch via an adhesive.

7. A decal form according to claim 1, wherein the decal is affixed to a liner, and wherein the decal and liner are releasably affixed in the window over the adhesive release coating via an adhesive.

8. A decal form comprising a laminate construction of a base sheet and a cover sheet with a patch of adhesive release material formed on the base sheet between the base sheet and the cover sheet, wherein a decal window for receiving a decal is die cut from the cover sheet exposing the adhesive release material patch.

9. A decal form according to claim 8, further comprising a decal releasably affixed in the window over the adhesive release material patch.

10. A decal form according to claim 9, wherein the decal is sized smaller than the window.

11. A decal form according to claim 9, wherein the decal is releasably affixed in the window over the adhesive release material patch via an adhesive.

12. A decal form according to claim 9, wherein the decal is affixed to a liner, and wherein the decal and liner are releasably affixed in the window over the adhesive release coating via an adhesive.

13. A decal form according to claim 8, wherein the adhesive release material is silicone.

14. A decal form according to claim 8, wherein the cover sheet comprises a pressure sensitive (PS) material.

15. A decal form according to claim 14, wherein the PS material is at least 60# paper or synthetic material.

16. A method of constructing a decal form comprising:
(a) applying a patch of adhesive release material to one side of a base sheet;
(b) affixing a cover sheet to the base sheet covering the base sheet and adhesive release material patch;
(c) die cutting a window section in the cover sheet adjacent the adhesive release material patch; and
(d) removing the window section of the cover sheet to define a window exposing the adhesive release material patch.

17. A method according to claim 16, wherein step (d) is practiced via suction.

18. A method according to claim 16, further comprising, after step (a), printing an ink material over the adhesive release material patch.

19. A method according to claim 16, wherein step (b) is practiced by laminating the cover sheet and the base sheet together.

20. A method according to claim 16, further comprising, after step (d), releasably affixing a decal in the window over the adhesive release material patch.
